(19) United States
(12) Patent Application Publication
(10) Pub. No.: US 2026/0186374 A1
(43) Pub. Date: Jul. 2, 2026

(54) IRIS MODULE AND CAMERA MODULE INCLUDING THE SAME

(71) Applicant: SAMSUNG ELECTRO-MECHANICS CO., LTD., Suwon-si (KR)

(72) Inventors: Jaeki EOM, Suwon-si (KR); Kwang Youel RAA, Suwon-si (KR); Yongjoo JO, Suwon-si (KR)

(73) Assignee: SAMSUNG ELECTRO-MECHANICS CO., LTD., Suwon-si (KR)

(21) Appl. No.: 19/369,429

(22) Filed: Oct. 27, 2025

(30) Foreign Application Priority Data
Dec. 31, 2024 (KR) 10-2024-0202517
Jun. 18, 2025 (KR) 10-2025-0080316

(51) Int. Cl. G03B 9/06

(52) U.S. Cl. CPC G03B 9/06

(57) ABSTRACT

An iris module includes a base having a center opening; a rotator configured to rotate relative to the base; and an iris driver disposed between the base and the rotator. The rotator includes a lower surface portion disposed to face the base and having a hollow portion; a side surface portion bent upward from an inner side edge of the lower surface portion; and an upper surface portion extending inward from an upper end of the side surface portion and having a hollow portion

### CROSS-REFERENCE TO RELATED APPLICATIONS

This application claims the benefit under 35 USC 119(a) of Korean Patent Application Nos. 10-2024-0202517 filed on Dec. 31, 2024, and 10-2025-0080316 filed on Jun. 18, 2025, in the Korean Intellectual Property Office, the entire disclosures of which are incorporated herein by reference for all purposes.

### BACKGROUND

### 1. Field

The present disclosure relates to an iris module and a camera module including the same.

### 2. Description of the Background

With the rapid advancement of information communication technology and semiconductor technology, electronic devices tend to converge various functions and provide the converged functions beyond the scope of their traditional roles.

Cameras have become a standard feature in portable electronic devices such as smartphones, tablet PCs, and laptop computers, and their resolution and performance are advancing.

A bright lens (Low Fno Lens) is an important factor in improving the optical performance of a camera, and plays a particularly important role in improving the image quality in low-light conditions. However, bright lenses can actually reduce optical performance because they have a shallow depth of field and a narrow focal range. Therefore, a structure like an iris is needed that can adjust the brightness and depth of field appropriately by adjusting the aperture size of the lens.

However, the iris assembled on the upper surface of the lens has a problem in that the outer diameter of the upper part of the lens-iris structure increases due to its structural characteristics, which increases the outer diameter and height of the entire camera module, resulting in design interference with the portable electronic device to which the camera module is mounted.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an iris module includes a base having a center opening; a rotator configured to rotate relative to the base; and an iris driver disposed between the base and the rotator. The rotator includes a lower surface portion disposed to face the base and having a hollow portion; a side surface portion bent upward from an inner side edge of the lower surface portion; and an upper surface portion extending inward from an upper end of the side surface portion and having a hollow portion.

The iris driver may include an iris magnet disposed on either one of an upper surface of the base or the lower surface portion of the rotator, and an iris coil disposed on another of the upper surface of the base or the lower surface portion of the rotator.

The iris module may further include a rolling member disposed between an upper surface of the base and the lower surface portion of the rotator.

The iris module may further include a guide portion disposed on the base and configured to guide a rolling movement of the rolling member; and a first rolling portion disposed on the lower surface portion and corresponding to the guide portion.

The iris module may further include an iris blade disposed on the upper surface portion of the rotator; and an iris cover disposed above the iris blade, and configured to cover the rotator.

Either one or both of the rotator and the iris cover may include stainless steel (SUS).

The side surface portion of the rotator may include a first side surface portion connected to the lower surface portion, and a second side surface portion connected to the upper surface portion.

Either one or both of the first side surface portion and the second side surface portion may include an inclined surface having a smaller diameter in an upward direction.

In another general aspect, a camera module includes a housing having an internal space; a lens barrel accommodated in the internal space of the housing and including a plurality of lenses; and an iris module disposed adjacent to the lens barrel and configured to adjust a size of an incident hole. The iris module includes a base seated on a first surface of the lens barrel and having a center opening; a rotator configured to rotate relative to the base; and an iris driver disposed between the base and the rotator. The rotator includes a lower surface portion disposed to face the base and having a hollow portion; a side surface portion bent upward from an inner side edge of the lower surface portion and surrounding an upper portion of an outer surface of the lens barrel; and an upper surface portion extending inward from an upper end of the side surface portion and having a hollow portion.

The iris driver may include an iris magnet disposed on either one of an upper surface of the base or the lower surface portion of the rotator, and an iris coil disposed on another of the upper surface of the base or the lower surface portion of the rotator.

The camera module may further include a rolling member disposed between an upper surface of the base and the lower surface portion of the rotator.

The camera module may further include a first rolling portion disposed on the lower surface portion, and in contact with the rolling member; a guide portion disposed on the base and configured to guide a rolling movement of the rolling member; and a second rolling portion disposed on the first surface of the lens barrel and in contact with the rolling member.

The camera module may further include an iris blade disposed on the upper surface portion of the rotator; and an iris cover disposed above the iris blade, and configured to cover the rotator.

Either one or both of the rotator and the iris cover may include stainless steel (SUS).

The side surface portion of the rotator may include a first side surface portion connected to the lower surface portion, and a second side surface portion connected to the upper surface portion.

Either one or both of the first side surface portion and the second side surface portion may include an inclined surface having a smaller diameter in an upward direction.

The iris driver may be disposed below an upper surface of the lens barrel.

Other features and aspects will be apparent from the following detailed description, the drawings, and the claims.

### BRIEF DESCRIPTION OF DRAWINGS

FIG. 1 is a perspective view showing an appearance of a camera module according to an embodiment.

FIG. 2 is an exploded perspective view schematically showing a camera module according to an embodiment.

FIG. 3 is an exploded perspective view showing an iris module according to an embodiment.

FIG. 4 is a perspective view showing a rotator of the iris module represented in FIG. 3.

FIG. 5 is a cross-sectional view showing a rotator of the iris module represented in FIG. 3.

FIG. 6 is a cross-sectional view according to a first direction of the camera module represented in FIG. 1.

FIG. 7 is a cross-sectional view according to another direction of the camera module represented in FIG. 1.

FIGS. 8A and 8B illustrate sizes of a camera module according to an embodiment and a camera module according to a comparative example.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

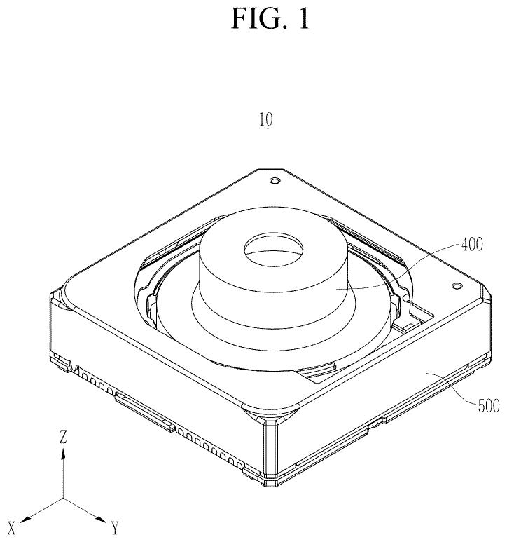

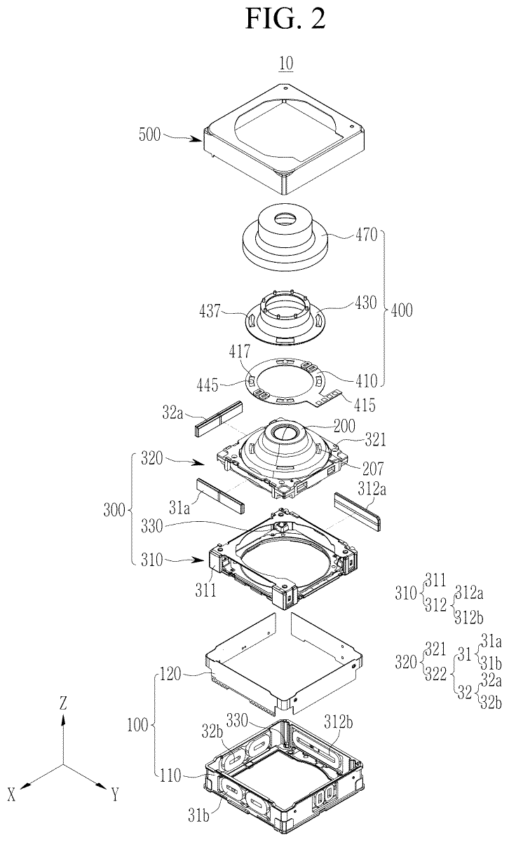

FIG. 1 is a perspective view showing an appearance of a camera module according to an embodiment. FIG. 2 is an exploded perspective view schematically showing a camera module according to an embodiment.

Referring to FIG. 1 and FIG. 2, a camera module 10 according to an embodiment may include a housing 100, a lens barrel 200, a lens driving module 300, an iris module 400, and a cover 500.

The housing 100 may include a housing main body 110 having an internal space and having an upper portion and a lower portion that are open, and a circuit board 120 located to cover a side surface of the housing main body 110. The lens barrel 200, the lens driving module 300, and the iris module 400 may be accommodated in the internal space of the housing 100. An image sensor unit (not shown) in which an image sensor converting incident light into an electrical signal may be disposed in a lower portion of the housing 100.

The lens barrel 200 may have a hollow cylindrical shape so that a plurality of lenses for imaging a subject may be accommodated therein. The plurality of lenses may be mounted on the lens barrel 200 along an optical axis. The plurality of lenses may be arranged in a desired number according to the design of the lens barrel 200, and each lens may have the same or different optical characteristics, such as a refractive index.

The lens driving module 300 may be a device configured to mount and move the lens barrel 200, and may include a focus adjustment portion 310 (e.g., auto focus (AF)) for adjusting focus, a shaking corrector 320 (e.g., optical image stabilization (OIS)) for compensating hand shake or shaking, and a rolling member 330.

The focus adjustment portion 310 may adjust the focus or implement a zoom function by moving the lens barrel 200 along an optical axis direction Z.

The focus adjustment portion 310 may include a focus carrier 311 accommodating the lens barrel 200, and a focus driver 312 generating the driving torque to move the lens barrel 200 and the focus carrier 311 along the optical axis direction Z. The focus driver 312 may include a focus driving magnet 312a mounted on a side surface of the focus carrier 311, and a focus driving coil 312b mounted on the side surface of the housing main body 110 and connected to the circuit board 120. The focus driving coil 312b may be installed in the housing main body 110, to face the focus driving magnet 312a.

The shaking corrector 320 may compensate for hand shaking or swaying at the time of photographing by moving the lens barrel 200 in a direction X or Y perpendicular to the optical axis direction Z.

The shaking corrector 320 may include a correction carrier 321 guiding a movement of the lens barrel 200, and a correction driver 322 generating a driving torque to move the correction carrier 321 in the direction X or Y perpendicular to the optical axis direction Z.

The correction carrier 321 may be accommodated within the focus carrier 311 and aligned along the optical axis direction Z, and may guide the movement of the lens barrel 200. The correction carrier 321 may have a center opening into which the lens barrel 200 can be inserted.

The correction driver 322 may include a first correction driver 31 including a first correction driving magnet 31a and a first correction driving coil 31b, and a second correction driver 32 including a second correction driving magnet 32a and a second correction driving coil 32b. The first correction driving magnet 31a and the second correction driving magnet 32a may be mounted on the correction carrier 321, and the first correction driving coil 31b and the second correction driving coil 32b, which face the first correction driving magnet 31a and the second correction driving magnet 32a, respectively, may be fixedly mounted on the housing main body 110 via the circuit board 120. The first correction driver 31 may generate the driving torque in a first direction X that is perpendicular to the optical axis direction Z, and the second correction driver 32 may generate the driving torque in a second direction Y that is perpendicular to the optical axis direction Z and the first direction.

The rolling member 330 may have a ball shape, and be installed between the focus carrier 311 and the housing 100, so that the friction between the focus carrier 311 and the housing 100 can be reduced when the focus carrier 311 moves along the optical axis direction Z. In addition, the rolling member 330 may be installed between the focus carrier 311 and the correction carrier 321, so that the friction between the correction carrier 321 and the correction driver 322 can be reduced.

The cover 500 may be coupled to the housing 100, to surround an outer surface of the housing 100. The cover 500 may protect the lens barrel 200, the lens driving module 300, and the iris module 400, which are located in the internal space of the housing 100, from an external physical impact, or shield electromagnetic waves.

The iris module 400 may be disposed adjacent to the lens barrel 200 and may selectively change the amount of light incident on the lens barrel 200 by adjusting the size of an incident hole. The iris module 400 may be disposed on an upper end of the lens driving module 300, and may be located at a front of the lens driving module 300 based on the light-incident direction. The iris module 400 may be coupled to the lens driving module 300, so as to move in the optical axis direction Z, the first direction X, and the second direction Y, together with the lens driving module 300. The iris module 400 can allow a relatively small amount of light to enter the lens barrel 200 in a high-light environment, and a relatively large amount of light to enter the lens barrel 200 in a low-light environment, so that the quality of the image may be constantly maintained in various lighting conditions.

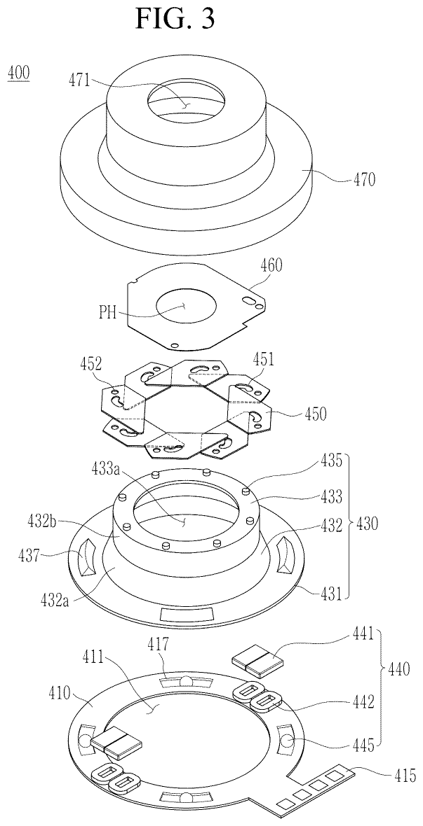

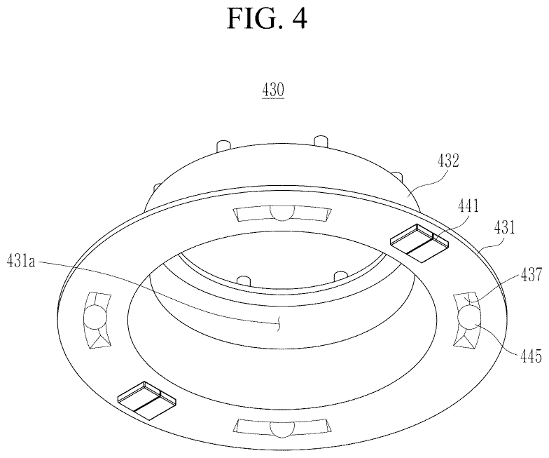

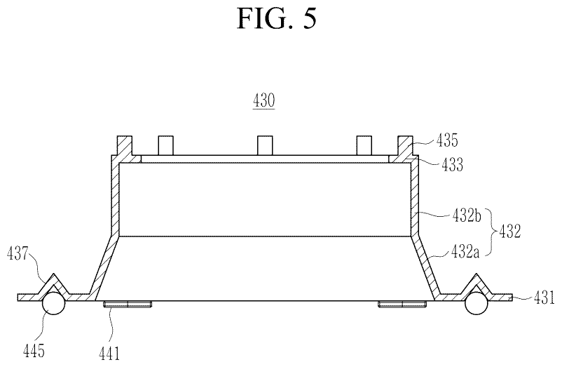

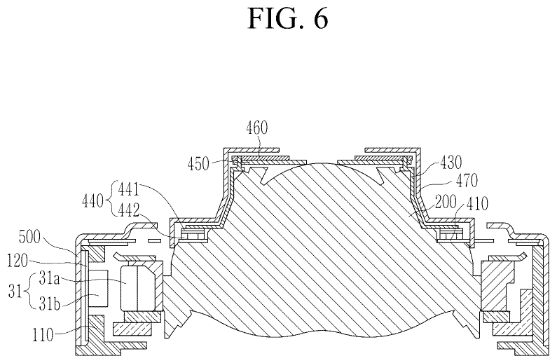

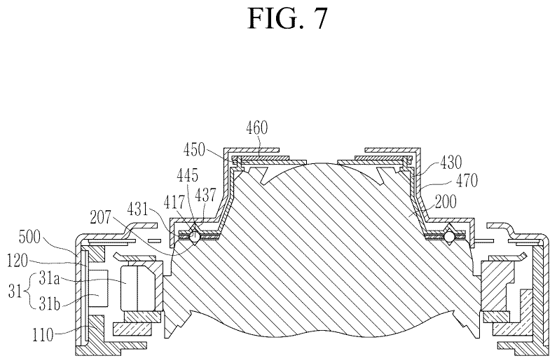

FIG. 3 is an exploded perspective view showing an iris module according to an embodiment. FIG. 4 is a perspective view showing a rotator of the iris module represented in FIG. 3. FIG. 5 is a cross-sectional view showing a rotator of the iris module represented in FIG. 3. FIG. 6 is a cross-sectional view according to a first direction of the camera module represented in FIG. 1. FIG. 7 is a cross-sectional view according to another direction of the camera module represented in FIG. 1.

Referring to FIG. 3 to FIG. 7, the iris module 400 according to an embodiment may include a base 410, a rotator 430, an iris driver 440, an iris blade 450, a gap spacer 460, and an iris cover 470.

The base 410 may be disposed on a first surface of the lens barrel 200, and may be formed of a roughly ring-shaped circular plate having an opening 411 at a center. The iris driver 440, the rotator 430, the iris blade 450, the gap spacer 460, and the iris cover 470 may be sequentially stacked above the base 410, in the optical axis direction Z. The base 410 may be coupled to the iris cover 470 and protect the iris blade 450 and the gap spacer 460 disposed therein from the outside.

The base 410 may be a circuit board applying power to the iris driver 440, and a circuit board having a wire pattern, such as a flexible circuit board or, rigid-flexible circuit board. The base 410 may include a connection portion 415 connected to the circuit board 120.

A guide portion 417 that accommodates a rolling member 445 guiding a rotation of the rotator 430 may be formed on the base 410. The guide portion 417 may be formed in a plural quantity along a circumferential direction, as a penetration hole in an approximately curved form, and may guide a rolling movement of the rolling member 445.

The rotator 430 may rotate relatively to the base by the electromagnetic influence generated by the iris driver 440. The iris blade 450 may be rotated by the rotation of the rotator 430, and accordingly, the size of the incident hole may be adjusted.

The rotator 430 may include a lower surface portion 431 disposed to face the base 410, a side surface portion 432 extending upward from the lower surface portion 431, and an upper surface portion 433 extending inward from the side surface portion 432.

The lower surface portion 431 may be formed of a roughly ring-shaped circular disc having a hollow portion 431a. The side surface portion 432 may be formed to be bent upward from an inner side edge of the lower surface portion 431. The upper surface portion 433 may be a roughly ring-shaped circular plate having a hollow portion 433a, and may extend inward from an upper end of the side surface portion 432.

A first rolling portion 437 in contact with the rolling member 445 may be formed on the lower surface portion 431. The first rolling portion 437 may be formed to correspond to the guide portion 417, and may include a rolling surface in a form convex upward, to accommodate a part of the rolling member 445. The first rolling portion 437 may have, for example, a cross-section in the optical axis direction in the shape of a mountain (\hat{ }), and may include a pair of rolling surfaces that face each other at a predetermined angle.

The side surface portion 432 may include a first side surface portion 432a connected to the lower surface portion 431, and a second side surface portion 432b connected to the upper surface portion 433. At least one of the first side surface portion 432a and the second side surface portion 432b may be formed of an inclined surface having a smaller diameter in an upward direction. For example, the first side surface portion 432a may be formed as the inclined surface while the second side surface portion 432b is formed as a surface perpendicular to the upper surface portion 433. Alternatively, both the first side surface portion 432a and the second side surface portion 432b may be formed as inclined surfaces, in which case the inclination angle of the first side surface portion 432a relative to the lower surface portion 431 may be smaller than the inclination angle formed by the second side surface portion 432b.

The rotator 430 may be made of stainless steel (SUS) to minimize thickness and reinforce strength. However, for parts that are difficult to process with stainless steel, plastic polymer materials such as polycarbonate (PC) may be used.

The iris driver 440 may be disposed between the base 410 and the rotator 430, and may include an iris magnet 441 and an iris coil 442. The iris driver 440 may be disposed below an upper surface of the lens barrel 200.

The iris magnet 441 and the iris coil 442 may be disposed to face each other on an upper surface of the base 410 and the lower surface portion 431 of the rotator 430. That is, the iris magnet 441 may be disposed on one of the upper surface of the base 410 and the lower surface portion 431 of the rotator 430, and the iris coil 442 may be disposed on the remaining one. For example, the iris magnet 441 may be disposed on a lower surface of the lower surface portion 431 of the rotator 430, and the iris coil 442 may be disposed on the upper surface of the base 410. At this time, in order to apply power to the iris coil 442, a connecting member (not shown) may be employed to electrically connect the base 410 and the circuit board 120, or the base 410 may be extended to an upper end of the circuit board 120 to be directly connected to the circuit board 120.

When power is applied to the iris coil 442, the rotator 430 on which the iris magnet 441 is mounted may reciprocate in a direction perpendicular to the optical axis direction by the electromagnetic influence between the iris magnet 441 and the iris coil 442. The rotator 430 may rotate due to its shape, and accordingly, the size of the incident hole of the iris module 400 may be adjusted.

The rolling member 445 may be disposed between the upper surface of the base 410 and the lower surface portion 431 of the rotator 430, to guide a rotational movement of the rotator 430. That is, when the rotator 430 rotates, the rolling member 445 may reduce the friction between the lower surface portion 431 of the rotator 430 and the base 410 or the lens barrel 200.

So as to accommodate the rolling member 445 and guide the rolling movement of the rolling member 445, the guide portion 417 may be formed in the base 410, the first rolling portion 437 may be formed in the lower surface portion 431 of the rotator 430, and a second rolling portion 207 may be formed in the first surface of the lens barrel 200. The guide portion 417 may be in the form of a roughly ring-shaped circular hole that penetrates the base 410 in a thickness direction, and the first rolling portion 437 and the second rolling portion 207 may include a rolling surface in contact with the rolling member 445. The first rolling portion 437 may include a rolling surface in a convex shape, to accommodate an upper portion of the rolling member 445, and the second rolling portion 207 may include a rolling surface in a concave shape, to accommodate a lower portion of the rolling member 445. For example, the first rolling portion 437 may have a cross-section in the optical axis direction that is approximately in the shape of a mountain (\hat{ }), and the second rolling portion 207 may have a cross-section in the optical axis direction that is approximately in the shape of the letter ‘V’.

The rolling member 445 may, for example, be formed in a ball shape, and a plurality of such balls may be disposed between the first rolling portion 437 and the second rolling portion 207, arranged along the circumferential direction while being accommodated in the guide portion 417.

The rolling member 445 may reduce the frictional force between the base 410 and the rotator 430, and facilitate the rotational movement of the rotator 430. In addition, the rolling member 445 may constantly maintain an interval between the base 410 and the rotator 430, so that the iris magnet 441 and the iris coil 442 may not contact each other when the rotator 430 rotates. To this end, the diameter of the rolling member 445 may be formed to be greater than the thickness of the iris magnet 441 and the iris coil 442.

A plurality of iris blades 450 may be provided, and a guide slit 451 of each iris blade 450 may be coupled to a plurality of guide protrusions 435 formed spaced apart with a regular interval on the upper surface portion 433 of the rotator 430. The guide slit 451 is a penetration hole that extends in a curved shape, and can guide a rotation of the iris blade 450 when the rotator 430 rotates. A fixing protrusion (not shown) that fixes the iris blade 450 may be formed in the upper surface portion 433 of the rotator 430, and a fixing groove 452 of each iris blade may be coupled to the fixing protrusion.

When the rotator 430 rotates by the electromagnetic influence between the iris magnet 441 and the iris coil 442, the plurality of guide protrusions 435 formed on the upper surface portion 433 of the rotator 430 can rotate the iris blade 450 around the fixing protrusion while moving in the guide slit 451 of each iris blade 450. The iris blade 450 may rotate within a range to open and close the hollow 433a of the upper surface portion 433 of the rotator 430, thereby adjusting the size of the incident hole.

The gap spacer 460 may be disposed adjacent to the iris blade 450, and may adjust a maximum size of the incident hole. The gap spacer 460 may have a through-hole PH that has a smaller size than the greatest incident hole formed by the iris blade 450 and a greater size than a medium-sized incident hole. The through-hole PH of the gap spacer 460 may be aligned with the incident hole formed by the iris blade 450 in the optical axis direction Z.

The greatest incident hole implemented by the iris module 400 of the present embodiment may be the size of the through-hole PH of the gap spacer 460. In order to cope with a situation where the shape of the incident hole cannot maintain the intended shape due to tolerance, or the like, the incident hole may be set to the maximum size by using the gap spacer 460. Although it has been illustrated and described in the present embodiment that the gap spacer 460 is disposed above the iris blade 450, the present disclosure is not limited thereto, and the gap spacer 460 may be disposed below the iris blade 450.

The iris cover 470 may be located above the iris blade 450 and may cover the rotator 430. The gap spacer 460 may be disposed between the iris cover 470 and the iris blade 450, and the iris cover 470 may be engaged with the base 410.

The iris cover 470 may be made of stainless steel (SUS) to minimize thickness and reinforce strength. However, for parts that are difficult to process with stainless steel, plastic polymer materials such as polycarbonate (PC) may be used.

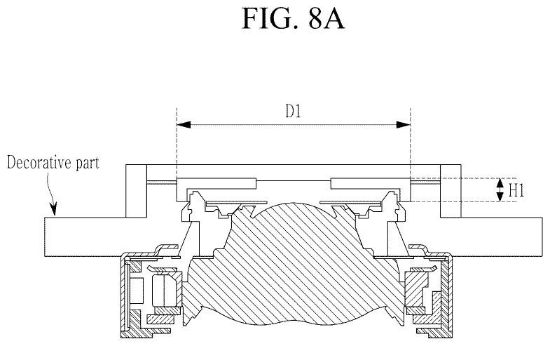

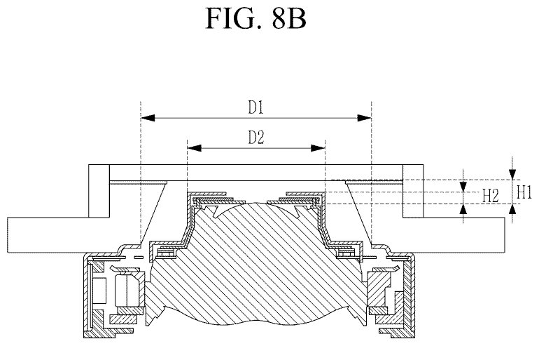

Hereinafter, referring to FIGS. 8A and 8B, the sizes of camera modules according to an embodiment and a comparative example will be described in detail. FIGS. 8A and 8B illustrate the sizes of a camera module according to an embodiment and a camera module according to a comparative example.

As shown in FIG. 8A, according to a camera module according to a comparative example, since an outer diameter D1 of the iris module is large and a height H1 of an upper surface portion of the lens is high, there may occur an interference with a decorative part of a portable electronic device on which the camera module is to be mounted when assembling the camera module.

On the other hand, as shown in FIG. 8B, it may be seen that, according a camera module according to an embodiment, since an outer diameter D2 of the iris module is far smaller than that of the comparative example and a height H2 of an upper surface portion of the lens is lower than that of the comparative example, there may be a marginal space with respect to the decorative part and an interference with the decorative part may not occur when assembling the camera module.

As such, according to the present embodiment, the thickness of the iris module may be minimized, thereby minimizing and slimming the outer diameter size of the lens-iris assembly, thereby improving the ease of assembly of the camera module.

According to an iris module and a camera module including the same according to an embodiment, miniaturization and slimming of the iris may be achieved so that the optical performance may be improved without causing design interference with a portable electronic device to which the camera module is mounted.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An iris module, comprising:
a base having a center opening;
a rotator configured to rotate relative to the base; and
an iris driver disposed between the base and the rotator,
wherein the rotator comprises:
a lower surface portion disposed to face the base and having a hollow portion;
a side surface portion bent upward from an inner side edge of the lower surface portion; and
an upper surface portion extending inward from an upper end of the side surface portion and having a hollow portion.

2. The iris module of claim 1, wherein the iris driver comprises an iris magnet disposed on either one of an upper surface of the base or the lower surface portion of the rotator, and an iris coil disposed on another of the upper surface of the base or the lower surface portion of the rotator.

3. The iris module of claim 1, further comprising a rolling member disposed between an upper surface of the base and the lower surface portion of the rotator.

4. The iris module of claim 3, further comprising:
a guide portion disposed on the base and configured to guide a rolling movement of the rolling member; and
a first rolling portion disposed on the lower surface portion and corresponding to the guide portion.

5. The iris module of claim 1, further comprising:
an iris blade disposed on the upper surface portion of the rotator; and
an iris cover disposed above the iris blade, and configured to cover the rotator.

6. The iris module of claim 5, wherein either one or both of the rotator and the iris cover comprise stainless steel (SUS).

7. The iris module of claim 1, wherein the side surface portion of the rotator comprises a first side surface portion connected to the lower surface portion, and a second side surface portion connected to the upper surface portion.

8. The iris module of claim 7, wherein either one or both of the first side surface portion and the second side surface portion comprise an inclined surface having a smaller diameter in an upward direction.

9. A camera module, comprising:
a housing having an internal space;
a lens barrel accommodated in the internal space of the housing and comprising a plurality of lenses; and
an iris module disposed adjacent to the lens barrel and configured to adjust a size of an incident hole, the iris module comprising:
a base seated on a first surface of the lens barrel and having a center opening;
a rotator configured to rotate relative to the base; and
an iris driver disposed between the base and the rotator,
wherein the rotator comprises:
a lower surface portion disposed to face the base and having a hollow portion;
a side surface portion bent upward from an inner side edge of the lower surface portion and surrounding an upper portion of an outer surface of the lens barrel; and
an upper surface portion extending inward from an upper end of the side surface portion and having a hollow portion.

10. The camera module of claim 9, wherein the iris driver comprises an iris magnet disposed on either one of an upper surface of the base or the lower surface portion of the rotator, and an iris coil disposed on another of the upper surface of the base or the lower surface portion of the rotator.

11. The camera module of claim 9, further comprising a rolling member disposed between an upper surface of the base and the lower surface portion of the rotator.

12. The camera module of claim 11, further comprising:
a first rolling portion disposed on the lower surface portion, and in contact with the rolling member;
a guide portion disposed on the base and configured to guide a rolling movement of the rolling member; and
a second rolling portion disposed on the first surface of the lens barrel and in contact with the rolling member.

13. The camera module of claim 9, further comprising:
an iris blade disposed on the upper surface portion of the rotator; and
an iris cover disposed above the iris blade, and configured to cover the rotator.

14. The camera module of claim 13, wherein either one or both of the rotator and the iris cover comprise stainless steel (SUS).

15. The camera module of claim 9, wherein the side surface portion of the rotator comprises a first side surface portion connected to the lower surface portion, and a second side surface portion connected to the upper surface portion.

16. The camera module of claim 15, wherein either one or both of the first side surface portion and the second side surface portion comprise an inclined surface having a smaller diameter in an upward direction.

17. The camera module of claim 9, wherein the iris driver is disposed below an upper surface of the lens barrel.
